(19) United States
(12) Patent Application Publication
(10) Pub. No.: US 2015/0164719 A1
(43) Pub. Date: Jun. 18, 2015

(54) SEAT STRUCTURE WITH SIT-TO-STAND FEATURE

(71) Applicant: SKIP'S PATENTS, LLC, Springport, MI (US)

(72) Inventors: Daniel T. GREEN, Monroe, MI (US); Maurice H. DOWDING, Springport, MI (US); Susan E. PERRY, Olivet, MI (US)

(21) Appl. No.: 14/628,669

(22) Filed: Feb. 23, 2015

Related U.S. Application Data
(63) Continuation of application No. 13/185,855, filed on Jul. 19, 2011, now Pat. No. 8,973,997.

(51) Int. Cl. A61G 5/14

(52) U.S. Cl. CPC A61G 5/14; A61G 2005/125

(57) ABSTRACT

A stand chair is operated by a pair of screw shaft-type linear actuators which extend upwardly and forwardly from a pair of spaced-apart frame members. One embodiment has a solid seat and another has a split sweat with a drop-away front portion. One or more motors are provided to operate the screw shafts in such a way as to raise the rear seat portion without changing its angular orientation in space. Connector links interconnect the frame with the front seat portion so as to cause it to drop downwardly out from under the thighs of an occupant, while the back seat portion raises upward, thereby assisting the occupant to stand up and exit the chair. Various additional features such as armrests, wheels and a reclining backrest may also be provided.

### CROSS-REFERENCE TO RELATED APPLICATION

This application is a continuation of the co-pending U.S. patent application Ser. No. 13/185,855 filed Jul. 19, 2011. The entire contents of applications Ser. No. 13/185,855 are incorporated herein by reference.

### FIELD OF THE INVENTION

This invention relates to seat structures of the type which are capable of selectively elevating so as to assist a person in getting into or out of a seat area.

### BACKGROUND OF THE INVENTION

It is known to incorporate a lift mechanism into a chair to assist an occupant to sit on or get up from the chair. By way of example, U.S. Pat. No. 5,984,411 issued Nov. 16, 1999 to Michael H. Galumbeck discloses a stand chair having an articulated or “split” seat which tilts forward as it is caused to rise up by a single screw drive actuator. As the chair rises, the seat and backrest tip forward and the front portion of the split seat drops away from under the occupant's thighs.

U.S. Pat. No. 7,540,565 issued Jun. 2, 2009 to William D. Lipford shows a similar chair with a split seat which also tips forward as the seat rises. In the Lipford chair, a screw drive causes the seat to rise out of contact with a pair of vertical support members 70.

### BRIEF SUMMARY OF THE INVENTION

One aspect of the present invention is to provide a lift mechanism which can safely and smoothly raise and lower a seat to provide assistance to a user. Although described herein as applied to various types of chairs, it is to be understood that the mechanism can be used in other seat structures such as those associated with toilets, treatment facilities, theaters, dining facilities, shower or bathing facilities, mobile vehicles and other devices.

In general, the lift mechanism comprises a pair of upwardly and forwardly oriented actuators mechanically connectable between a base and a seat structure to raise the seat structure relative to the base on demand. In a specific form, the base can be a frame which carries two upwardly and forwardly oriented actuators which raise or lower the seat while maintaining it in a constant orientation in space. The actuators are described herein as screw-type actuators but may be implemented in various other forms including hydraulic and/or pneumatic cylinder actuators.

According to another aspect of the invention, a “stand chair” is provided which employs either a solid or split seat and which incorporates a lift mechanism which is so arranged as to maintain the orientation of a seat constant as the seat rises up to facilitate or assist a person to get up from a seated position to a standing position.

In one embodiment, the chair has a seat which may be split into front and rear portions. The front portion is arranged so that its angular relationship to the rear seat portion changes as the rear portion rises and/or lowers. Alternatively, the seat can be solid. One or more motors are located under the seat and connected to actuators which raise and lower the seat relative to a base. The motor or motors may be mounted in any of several locations; for example, they may be attached to a seat pan so as to go up and down with the seat.

It will be understood that in the embodiments using electric motors, those motors may take AC or DC power or both. A battery-powered embodiment is disclosed along with a power supply which can recharge the battery from an AC source. This is not an exhaustive list of power sources; for example, the actuators associated with a shower or bathing facility may be powered by the pressure of water available from a nearby tap.

### BRIEF DESCRIPTION OF THE DRAWINGS

The description herein makes reference to the accompanying drawings wherein like reference numerals refer to like parts throughout the several views and wherein:

FIG. 1 is a perspective view of a first chair embodying the basic structure of the present invention with the seat and seat back in a normal sitting position;

FIG. 2 is a perspective view of a chair similar to the FIG. 1 embodiment but incorporating a split seat;

FIG. 3 is a side view of the chair of FIG. 2;

FIG. 4 is a side view of the chair of FIG. 2 with the seat and seat back in a raised position;

FIG. 5 is a perspective view of an embodiment of the invention configured as a transport chair and having an auxiliary battery power for operation of the actuators;

FIG. 6 is a perspective view of another transport chair embodiment of the invention with a reclining seat back capable of assuming a “Trendelenburg” position;

FIG. 7 is a view of the embodiment of FIG. 6 with the seat back in a supine position and further incorporating support structure for the seat back;

FIG. 8 is a side view of another embodiment of the invention with the seat in the supine position;

FIG. 9 is the chair of FIG. 8 with the seat in the raised/split position;

FIG. 10 is a perspective view of the bottom of the FIG. 8 chair showing one way of mounting mechanical components;

FIG. 11 is a diagram of control components in a microprocessor-based embodiment; and

FIG. 12 is a perspective view of an example of how a chair embodying the invention might be commercially packaged for general use.

### DETAILED DESCRIPTION OF THE ILLUSTRATIVE EMBODIMENTS

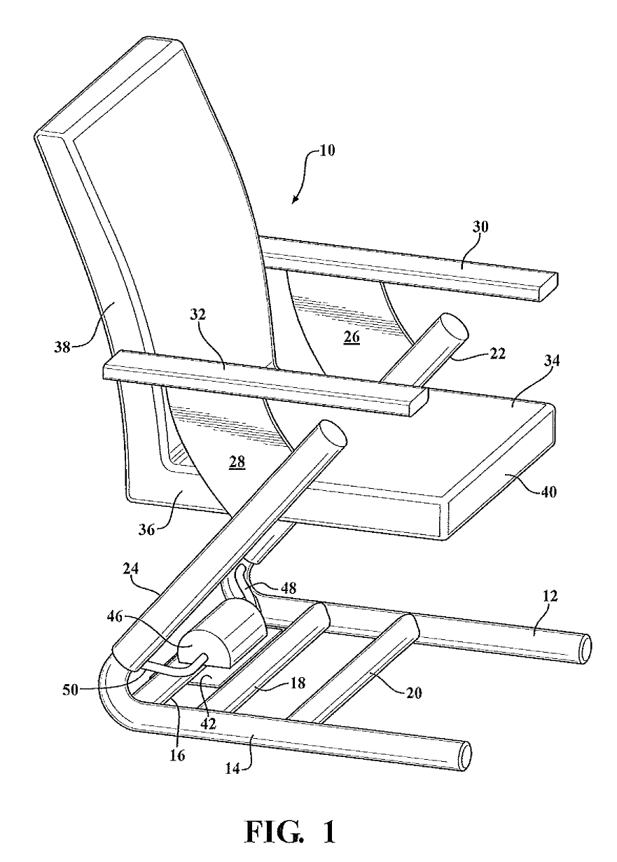

Referring to FIG. 1 there is shown a chair 10 comprising a base in the form of a tubular metal frame having parallel spaced-apart ground engaging leg members 12, 14 joined by welded cross-members 16, 18, 20. The tubular frame members 12, 14 are integral with upwardly and forwardly extending legs to receive actuators 22, 24 having upwardly and forwardly movable cylindrical outer housings which are mechanically attached such as by welding to arcuate metal plates 26, 28 which are in turn connected as support members to parallel spaced-apart armrests 30, 32 and, via the armrests, to a seat 34.

The seat 34 is disposed between and connected by plates 26, 28 to the actuators 22, 24 so that the elevation of the seat 34 relative to the frame 12, 14 can be changed. Seat 34 is, in this embodiment, rigidly connected to a backrest 38 with armrests 30, 32. At least the seat 34 and backrest 38 are cushioned and upholstered.

A plate 42 is welded between the cross-members 16, 18 to receive a motor 46 which is connected to the actuators by cables 48, 50 so as to cause the actuators 22, 24 to raise and lower the seat 34 and armrests 30, 32 in unison. The motor 46 is excited by current which can be produced either by battery or by AC line voltage source. Alternatively or additionally, the system may have an AC to DC powered power converter which, when plugged in, keeps a battery charged.

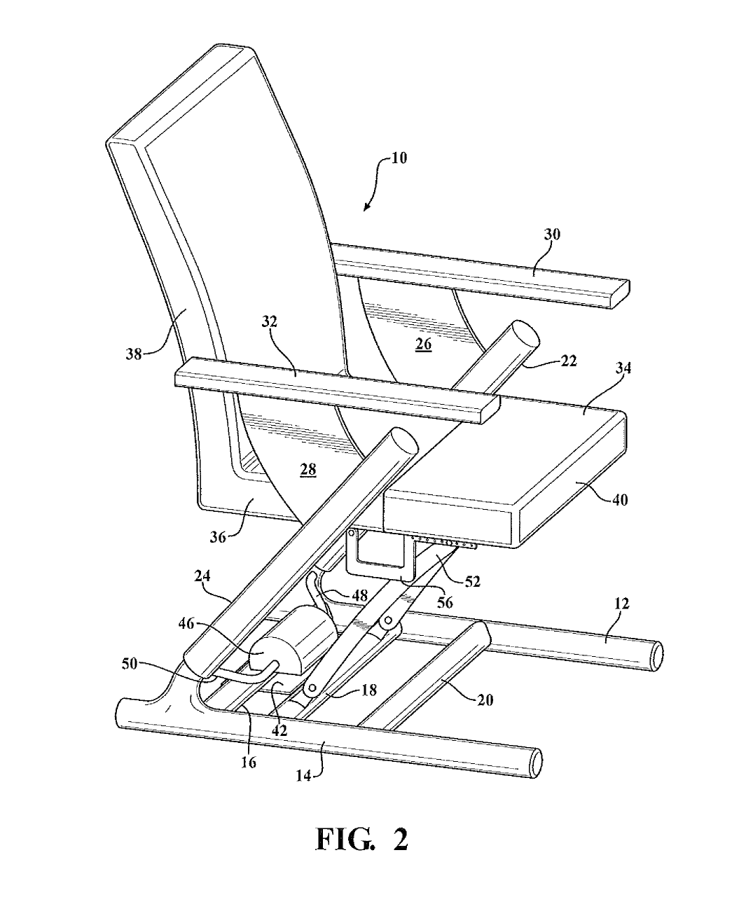

FIGS. 2 through 4 show a chair 10′ substantially similar to the chair of FIG. 1 except for the fact that the seat 34 is divided or “split” into rear and front portions 36, 40, respectively and the legs 12′ and 14′ have rear extensions to prevent tipping. The rear portion 36 is rigidly connected to backrest 38 as in the FIG. 1 embodiment. Front portion 40 is hinged to the rear portion by brackets 56 so that its orientation or angle in space can change relative to the rear portion 36 as the rear portion 36 changes in elevation. Other types of hinges can be used. For example, a pair of concentric tubes, one within the other, can be used as a hinge. Control links 52 are pivotally connected between the frame member 18 by brackets 56 on one end and the lower surface of front seat portion 40 on the other end to produce the orientation change. It will be noted that the rear seat portion 36 does not change orientation as it changes elevation.

The components of the embodiment of FIGS. 2-4 which are identical to components of the FIG. 1 embodiment are given the same reference numbers. For example, the actuators are given reference numbers 22 and 24 throughout this specification. Brackets 56 are also consistently numbered.

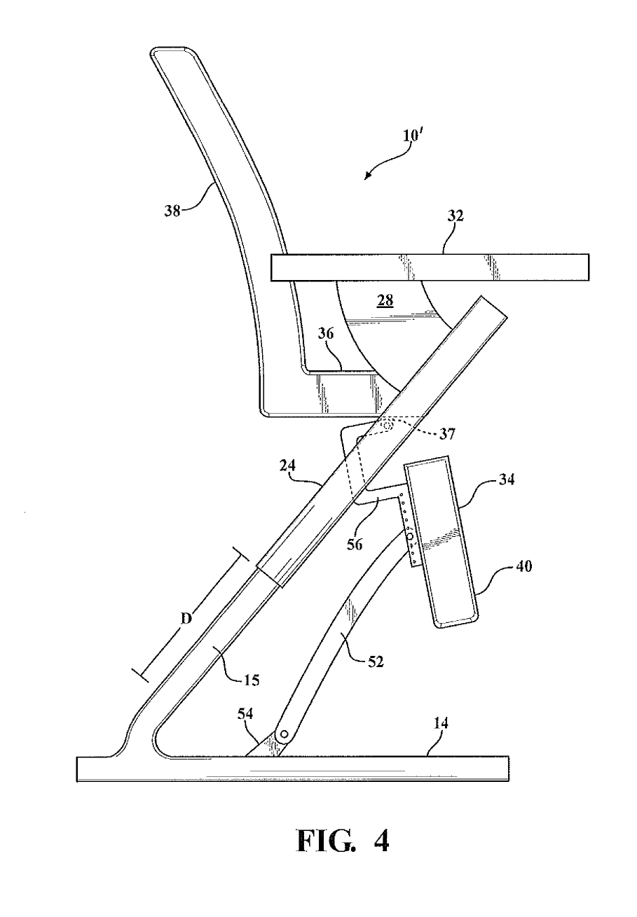

As shown in FIGS. 2-4, the links 52 cause the forward seat portion 40 to tilt downwardly as the rear portion 36 rises, thereby producing the change in orientation shown in FIG. 4.

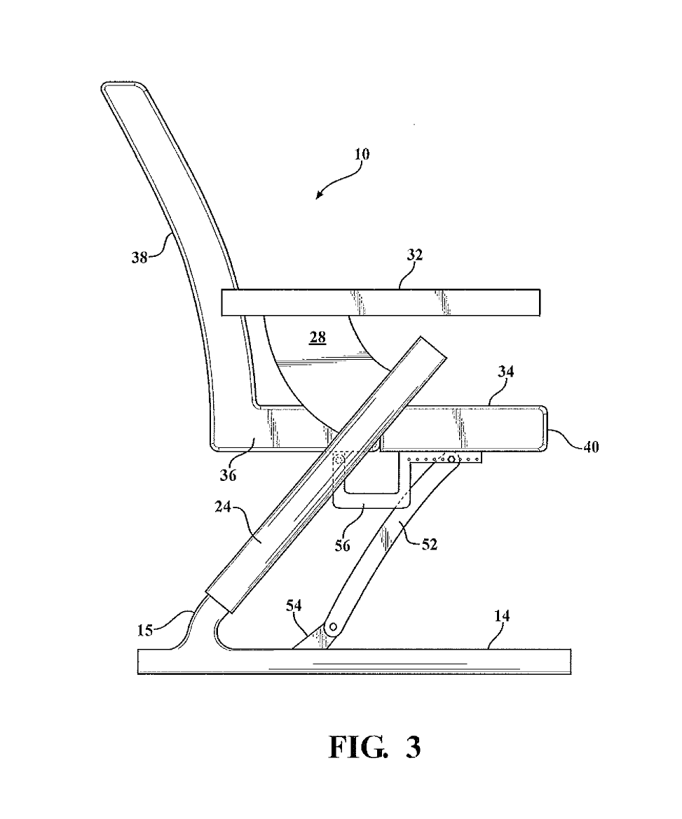

FIG. 3 shows the chair 10′ as described above with the seat portion 36 and the back rest 38 along with the armrests 30, 32 in the lowermost or normal sitting position. In this position, the forward seat portion 40 is in the same plane as the rear seat portion 36 to provide maximum support to the occupant. Note that there are holes in brackets 56 so that the attachment points of the links 52 can be adjusted to suit the individual user.

FIG. 4 illustrates the chair 10′ with the rear seat portion 36 and the seat back 38 in the raised or “stand” position caused by excitation of the motor 46 to cause the actuators 22, 24 to raise the seat upwardly and forwardly a distance D. Note that the connector links 52 assume a relatively constant position but cause the forward seat portion 40 to drop away from under the occupant's thighs, thus to facilitate departure of the occupant from the chair. Note also that the rear seat portion 36 and the seat back 38 is maintained in a substantially constant orientation; i.e., it has not tipped during the standing maneuver. Thus, an occupant enjoys a sensation of full support throughout the standing maneuver and never feels as though he or she is being thrust forwardly in such a way as to slide out of contact with the rear seat portion 36. This motion of rising to one's feet mimics the natural motion of standing from a seated position.

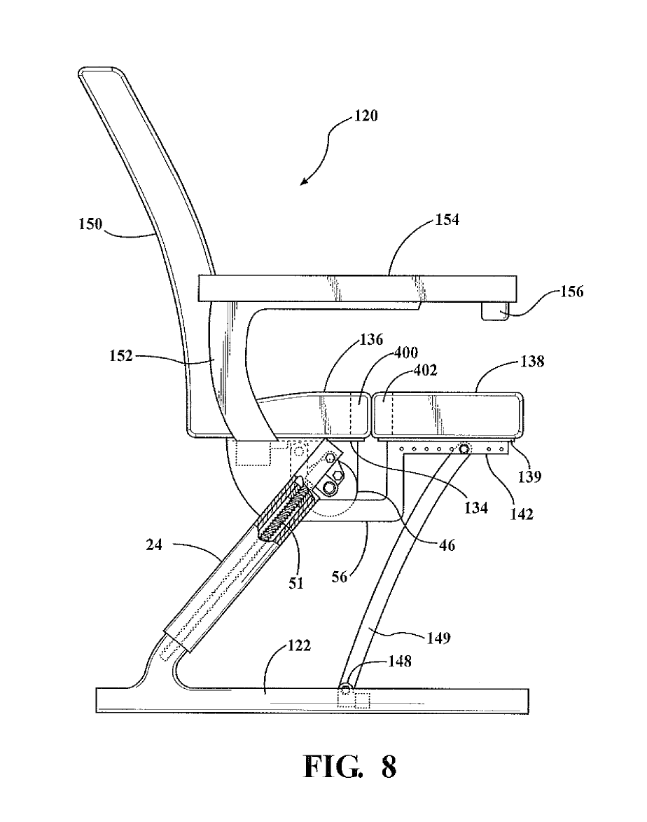

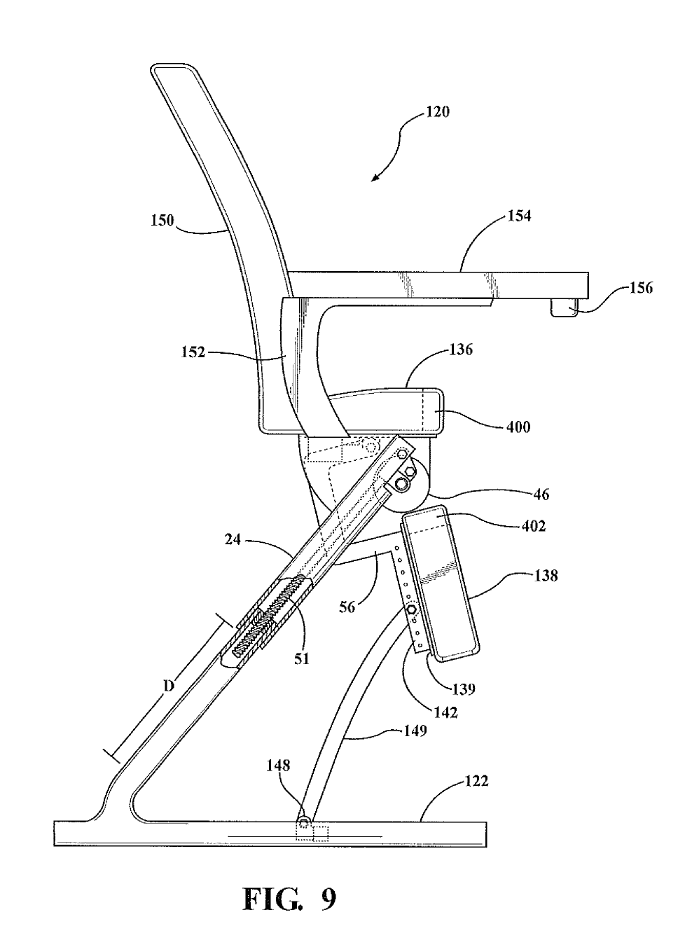

As shown in FIGS. 8 and 9, actuators 422, 424 take the form of jack screws with screw shafts 51 which extend under control of motor 46 to raise and lower the seat 36. A worm gear drive (not shown) rotates the screw shaft in a trapped nut (not shown) to extend and retract the shaft, which in turn raises and lowers the seat. Hydraulic or other actuators with conventional valve systems can also be used with substantially equivalent results. It will also be noted in FIGS. 2-4 that the links 56, while fixedly attached to the front seat portion 40, are pivotally connected at 37 to the bottom of the rear seat portion 36.

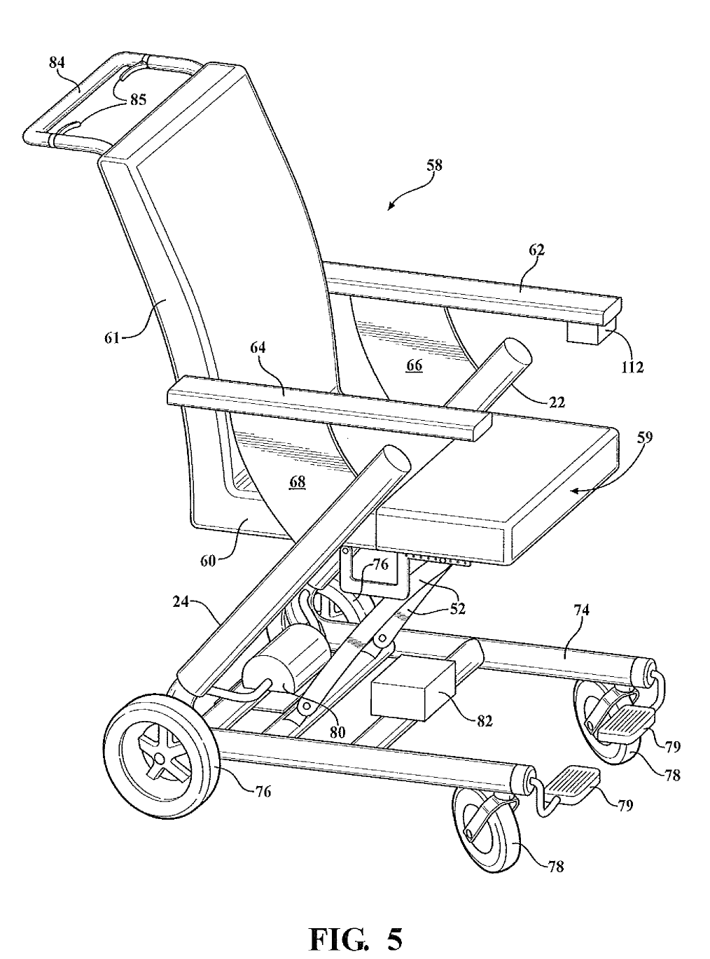

Referring to FIG. 5, a wheeled chair 58 is shown which as far as basic mechanical design is concerned, is substantially similar to the chair 10′ of FIGS. 2-4. The chair 58 comprises a split seat 59 with a rear portion 60 fixedly connected to a seat back 61 having parallel spaced-apart armrests 62, 64 attached by metal supports 66, 68 to actuators 422, 424 which are identical to the actuators shown in FIGS. 1 and 2. The actuators 22, 24 are connected to a frame 74 having longitudinal tubular components as well as cross-members as described above with reference to FIGS. 1-4. The FIG. 5 embodiment has a split seat, wheels 76, 78 and fold-up foot rests 79, as well as a push bar 84 with wheel lock release levers 85.

The embodiment of FIG. 5 is provided with self-locking rear wheels 76 which allow the chair to function as a wheel chair. The wheels 76 are self-lockable so as to prevent undesired motion of the chair unless the brakes are released by levers 85. In addition, the frame is provided with swivel-type front wheels 78. A battery 82 provides DC power to a motor 80 which, like the embodiments of FIGS. 1-4 is connected to the actuators 22, 24 in such a way that they are always operated in up and down directions in unison. The battery 82 may also have a plug-in power supply/charger.

It will be understood that the wheels 76, 78 shown in FIG. 5 are merely illustrative and that various other types and sizes of wheels can also be used. The footrests 79 are conventional fold-up devices and no further description is deemed necessary.

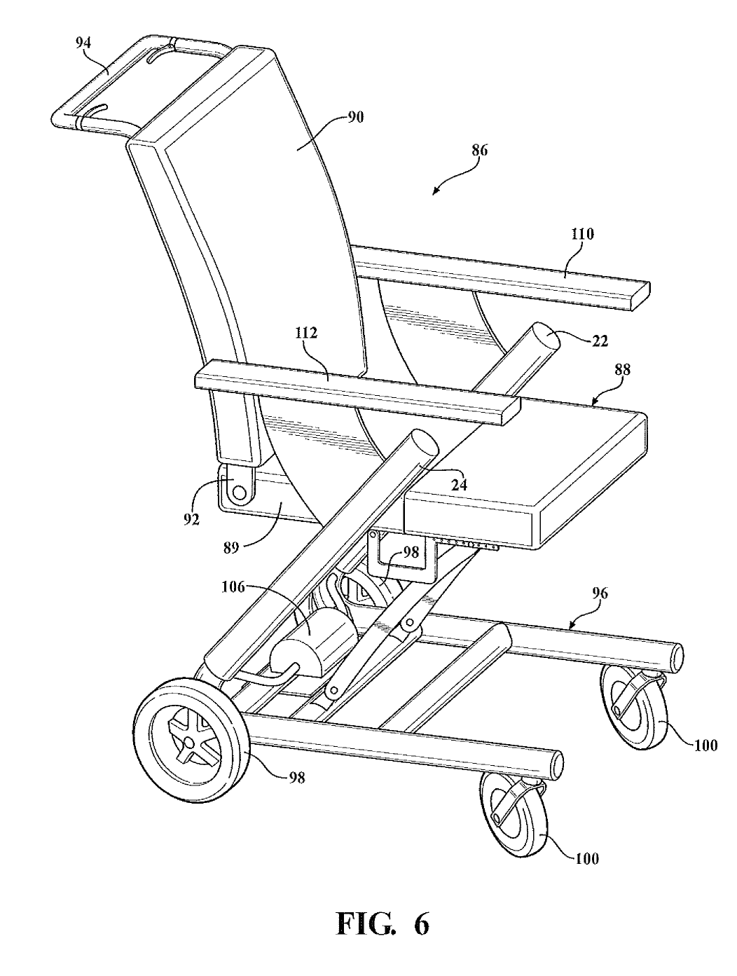

FIG. 6 shows another chair 86 substantially identical to the chair 58 of FIG. 5 and having a split seat 88 complete with seat back 90 as well as armrests 110, 112. Actuators 22, 24 operate in conjunction with a motor 106 to raise and lower the seat 88, 89, 90 relative to the frame 96 which, like the embodiment of FIG. 5, is equipped with wheels 98, 100.

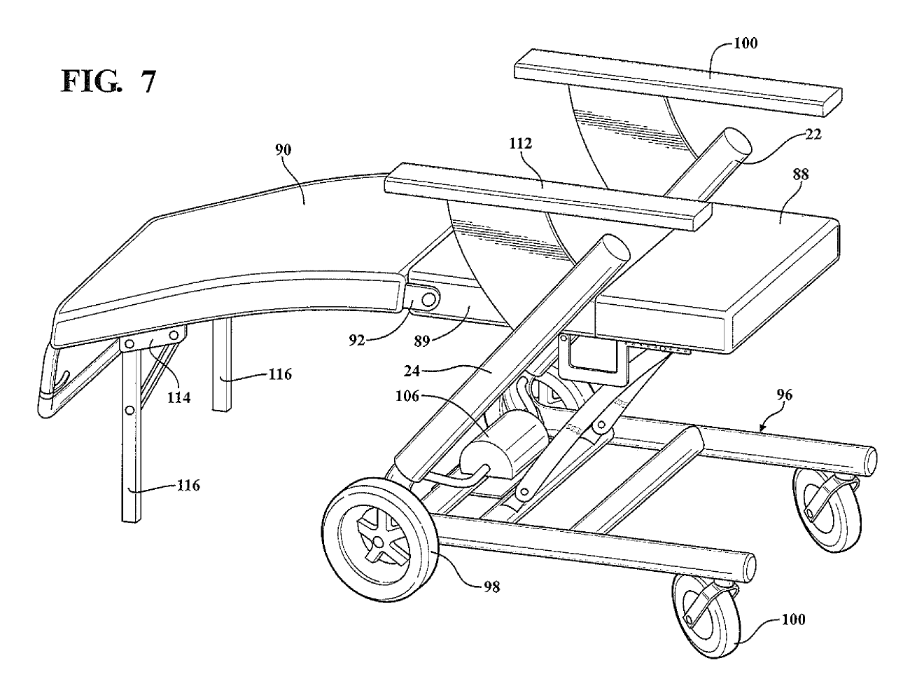

In the embodiment of FIGS. 6 and 7, the seat back 90 is connected by way of a releasable pivot 92 to the rear portion of the split lower seat 88 so that the seat back 90 may be lifted and then swung downwardly to a supine position shown in FIG. 7. It is often recommended that in the supine position, the seat back be oriented such that the user's head is somewhat lower than his or her head. Optional support legs 116 are connected to bracket 114 which in turn, are mounted by suitable fasteners to the seat back 90 so as to provide additional support for the seat back 90 when in the reclined position. Seat back 90 can be stopped at numerous positions between full up and the fully reclined position.

Referring to FIGS. 8, 9 and 10, a still further embodiment of the invention is illustrated. This embodiment, although generally similar to the embodiment of FIGS. 1-7, offers a number of advantages. Although illustrated as a stand chair 120 which is designed for stationary use; i.e., without wheels, and with a fixed angle seat back 150, it is to be understood that wheels, seat back pivots, push bars and other features of the embodiments of FIGS. 1 through 7 may be added to the embodiment of FIGS. 8 and 9 as desired.

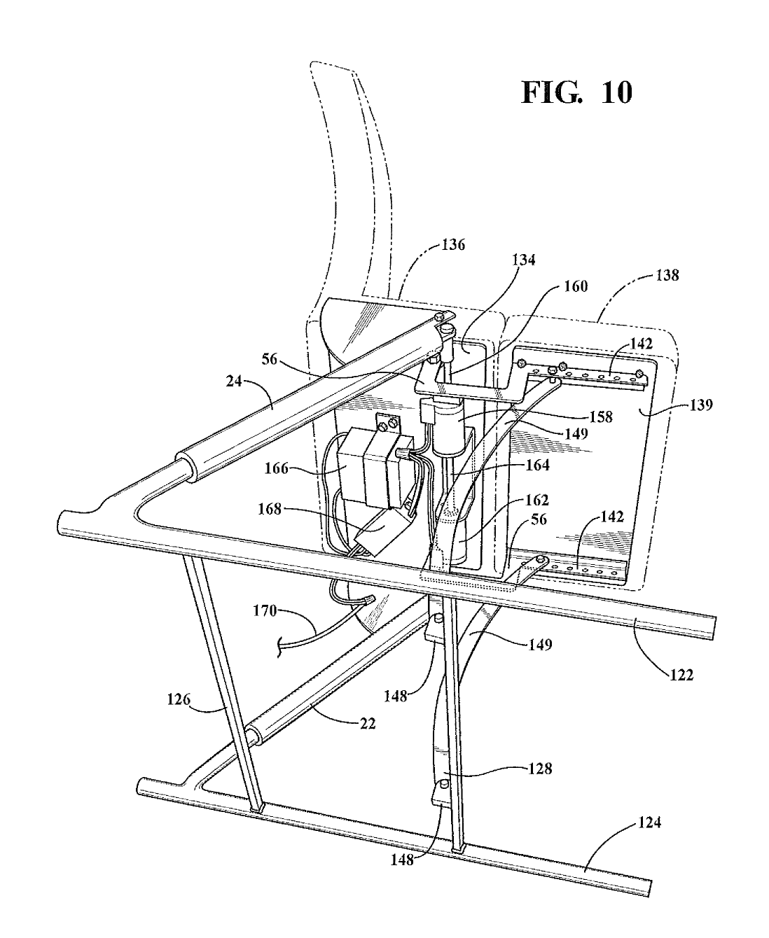

Chair 120 comprises a tubular frame 122, 124 having welded cross-braces 126, 128 between the lower horizontal portions thereof. Each of the frame elements 122, 124 has an upwardly extending portion at an acute angle to the ground legs to receive screw-type linear actuators 422, 424 which are connected at the upper output ends thereof to a seat pan 134 which carries, among other things, the rear portion 136 of a split seat 136, 138. The forward or front portion 138 is mounted on a steel pan 139, the pans 134, 139 being interconnected by brackets 56 which are welded to the pan 139 but are pivotally connected to the rear seat pan 134 to permit the front and rear seat portions to go from the flat mating condition shown in FIGS. 8 and 10 to the stand condition shown in FIG. 9. The large hinge brackets 56 permit the rigid portions of the rear and front seat portions 136, 138 to be spaced widely apart in the sitting position, the gap between them being filled by soft cushioning and upholstering material 400, 402 as shown in the figures so as to eliminate any “pinch point” between the seat portion.

Brackets 56 have integral front extensions 142 mounted such as by welding to the bottom of the front seat pan 139 not only to form part of the hinge linking the pans 134, 139 but also to receive the two parallel links 149. These links 149 are connected by pivots 148 to the cross brace 128 and operate to pivot or tilt the front seat portion downwardly as the rear seat 136 rises upwardly from the normal seating position. There are holes spaced along the brackets 56 so the links can be mounted or attached at various places along their lengths. As indicated above, brackets 56 are identical to the same parts in the embodiment of FIG. 2.

Armrest brackets 152 are welded to the sides of the seat pan 134 to support armrests 154 on the right and left sides of the chair 120. A control 156 is provided on one of the arms 154 for purposes to be described.

As shown in FIG. 10, a first motor 158 is connected through a flexible output shaft 160 to the linear actuator 424 to activate same; i.e., to extend or retract the screw shaft thereby raise and lower the seat portion 136 relative to the frame 122, 124 as desired. A second motor 162 is connected through a second flexible output shaft (hidden in FIG. 10) which is connected to the screw shaft of the actuator 422 in exactly the same fashion as the motor 158 is connected to the screw shaft of actuator 424. A flexible shaft 164 is connected between the two motors, 158, 162 to maintain them in sync so that one side of the chair does not rise or lower faster than the other side. This may also be done with one motor. The motors are mounted directly to the seat pan 134 to raise and lower along with the seat. In this embodiment, the worm gear drive for the screw shaft is at the top.

A battery pack 166 is mounted to the bottom side of the back seat pan 134 along with a motor controller 168, the two being connected to a suitable 120v AC power supply through line 170 as needed. A current sensor 168 detects the arrival of the lift mechanism at a travel limit as a function of motor current and a travel sensor located inside linear actuators 422, 424.

It will be appreciated from the foregoing description that FIG. 8 represents the chair 120 in the normal occupied condition wherein the rear and front seat portions 136, 138 are flat and immediately adjacent one another and the seating area is in the lowermost condition. When an occupant wishes to get up from the chair 120, he or she operates the motors through the control 156 to extend the screw shafts and the actuators 422, 424 thus causing the rear seat portion 136 and, in this embodiment, the seat back 150 to stand upwardly while maintaining a substantially constant angular orientation in space. As the rear seat portion 136 rises, the link 149 causes the forward seat portion 138 to swing down from the rear seat portion 136 as best shown in FIG. 8 and to change in angular orientation thereby facilitating the physical act of the occupant standing up and exiting the chair 120. The link 149 may be adjusted along the length of the bracket 56 according to the height of the occupant; holes in the brackets 56 and pins for the link 149 being provided for this relocation function.

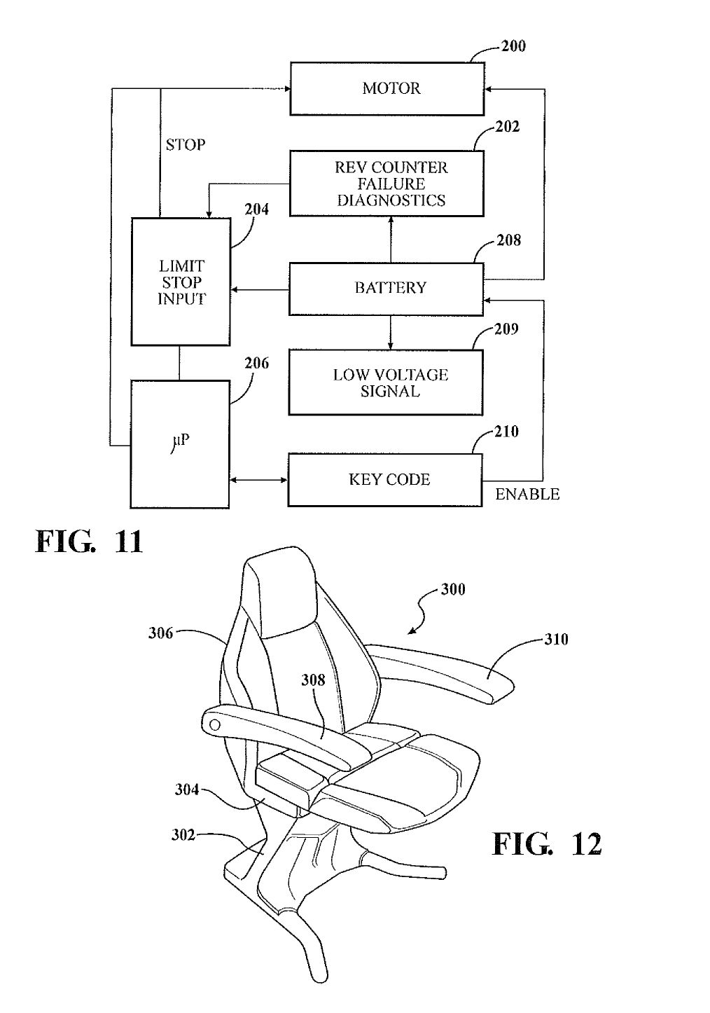

FIG. 11 illustrates in block diagram a controller for any or all of the chairs described above. A motor 200 operates the actuators for raising or lowering the seat as desired. Motor 200 is connected mechanically to a revolution counter 202 which may include a resolver or an optical pulse counter to keep track of how far the motor has extended or retracted the jack screw in the actuator controlled by motor 200. A programmable limit stop register 204 works in combination with microprocessor 206 to determine when to stop motor 200 at the selected limits of travel. These limits may be set by keyboard entry via processer 206 according to the size of the occupant/owner of the chair such that the register 204 sends a “stop” signal to motor 200 at the appropriate time. A battery 208 supplies power to motor 200 as well as a processor 206 via an appropriate voltage divider (not shown). Various diagnostic functions may be performed to ensure proper operation of the chair; for example, a low voltage detector 209 may be provided to issue an audible or visual alarm if battery voltage falls below a desired limit Finally, a key card reader, key code entry or override device 210 may be provided to “enable” the entire system only by an authorized user.

FIG. 12 is an illustration of an ornamental aesthetic design for a stationary stand chair 300 embodying the principles of the present invention. A base 302 contains actuators connected to seat portion 304 with integral backrest 306, the actuators being arranged essentially as shown in FIGS. 2-4. The seat can be split or unitary as desired. Arms 308, 310 may fold up. The seat can be upholstered in vinyl, leather, fabric or any combination of these.

It will be appreciated that the embodiments illustrated in the drawing and described above are exemplary and that implementation of the invention can be carried out in various other configurations.

What is claimed is:

1. A chair structure for assisting a person in need of assistance to move from a sitting position to a vertical standing position, said chair comprising:
an elongate base formed of a two spaced apart elongated tubular members for supporting said structure on a surface; each member having a section extending forward and upward at an acute angle from said base;
a seat structure having two tubular members extending telescopically relative to said forward and upward members, said structure having a seat portion for carrying said patient, said seat portion being mounted between said two tubular members to move said patient upward and forward; and
at least one actuator interconnected between said base and said seat structure for moving said seat and said patient in an upward and forward direction.

2. A chair as recited in claim 1 in which said actuator is an electric screw type actuator.

3. A chair as recited in claim 1 in which said actuator is a screw type actuator for reciprocating said seat in said upward and forward movement.

4. A chair structure for assisting a person in need of assistance to move from a sitting position to a vertical standing position with confidence and without fear of falling, said chair comprising:
a base formed of at least one tubular member having an elongated horizontal first section for supporting the chair upon a surface and a second section extending forward and upward from the first section;
a reciprocating support section having a forwardly and upwardly-extending member telescopically mounted to said second section and having a seat portion affixed thereto for carrying said patient, said seat portion being adapted to move said person upward and forward;
at least one actuator between said base and said reciprocating support section for reciprocating said seat portion and said patient in an upward and forward movement.

5. A chair structure for lifting an occupant from a first lower position to a second higher position to assist the occupant in achieving a standing position comprising:
a base comprising a pair of parallel spaced-apart, rigid tubular members, each having a horizontal first portion and an upwardly and forwardly extending second portion defining an acute angle between the first and second tubular member portions;
a seat structure including a substantially horizontal seat portion and a backrest portion; said seat structure further comprising a pair of rigid, elongate tubular members mechanically attached to the seat structure and located so as to telescopically receive the upwardly and forwardly second portions of said tubular base therein for upwardly and forwardly directed movement of said seat structure relative to the base.

6. A chair structure as defined in claim 5 wherein at least one cross-member is provided for integrally connecting the parallel horizontal spaced-apart portions of the base.

7. A chair structure as defined in claim 5 further including an actuator connected between the base and the seat structure for producing upwardly and forwardly directed movement of said seat structure relative to said base.

8. A chair structure as defined in claim 5 wherein the seat portion and the backrest portion are integral.

9. A chair structure as defined in claim 5 wherein the seat portion and the backrest portion are hingedly connected.

10. A chair structure as defined in claim 5 further including wheels attached to said base.

11. A chair structure as recited in claim 1 in which said seat structure includes at least one armrest extending forwardly for supporting the arms of the person and for providing support to said person as said person rises to said standing position.

12. A chair structure as recited in claim 11 in which said arm support carries a controller for initiating said upward and forward movement.

13. A chair structure as recited in claim 12 in which said controller includes a microprocessor for controlling said actuator.

14. A chair structure as recited in claim 13 in which said controller includes stop registers for limiting said upward and forward movement.

15. A chair structure as recited in claim 1 in which an actuator for moving said seat structure upward and forward is positioned within said spaced apart tubular members.

16. A chair structure as recited in claim 1 in which a separate actuator for moving said seat structure upward and forward is positioned within each of said spaced apart tubular members.

17. A chair structure as recited in claim 1 in which wheels are interposed between said horizontal first section and said surface for facilitating movement of said chair structure.

18. A chair structure as recited in claim 4 in which said seat structure:
a) includes at least one armrest extending forwardly for supporting the arms of the person and for providing support to said person as said person rises to said standing position and;
b) said arm support carries a controller for initiating said upward and forward movement.

19. A chair structure as recited in claim 18 in which said controller includes a microprocessor for controlling said actuator and said microprocessor is programmed to limit said upward and forward movement.

20. A chair structure as recited in claim 18 in which wheels are interposed between said horizontal first section and said surface for facilitating movement of said chair structure.
